(19) United States
(12) Patent Application Publication
(10) Pub. No.: US 2026/0157901 A1
(43) Pub. Date: Jun. 11, 2026

(54) OVERHEAD SUPPORT ASSEMBLIES INCLUDING A BOOM ARM AND A RAIL FOR A PERSON LIFT SYSTEM

(71) Applicant: Baxter Medical Systems GmbH + Co. KG, Saalfeld (DE)

(72) Inventors: Gunter Löffl, München (DE); Georg Bauer, München (DE); Debao Ma, Taicang (CN); Robert Eneslätt, Luleå (SE)

(73) Assignee: Baxter Medical Systems GmbH + Co. KG, Saalfeld (DE)

(21) Appl. No.: 19/404,783

(22) Filed: Dec. 1, 2025

Related U.S. Application Data
(60) Provisional application No. 63/728,524, filed on Dec. 5, 2024.

(51) Int. Cl. A61G 7/10

(52) U.S. Cl. CPC A61G 7/1017; A61G 7/1042

(57) ABSTRACT

An overhead support assembly including a boom arm having a length extending between a first end and an opposite second end of the boom arm, the length of the boom arm being equal to or greater than 1,500 mm and less than or equal to 1,700 mm, a rail mounted to a lower wall of the boom arm, the rail having a length extending between a first end and an opposite second end of the rail, the rail including a receiver, the length of the rail being equal to or greater than 1,500 mm and less than or equal to 1,700 mm, and a person lift system received within the receiver of the rail to translate along the rail between the first end and the second end of the rail.

### CROSS-REFERENCE TO RELATED APPLICATION

This application claims the benefit of co-pending U.S. Provisional Patent Application No. 63/728,524, filed Dec. 5, 2024, for “Overhead Support Assemblies Including A Boom Arm And A Rail For A Person Lift System,” which is hereby incorporated by reference in its entirety including the drawings.

### TECHNICAL FIELD

The present specification generally relates to person lift systems and, more particularly, to person lift systems that are translatable along a boom arm of an overhead support assembly.

### BACKGROUND

Lift systems, such as person lift systems that include lift units such as mobile lifts and/or overhead lifts, may be used in hospitals and other health care facilities to move a person from one location to another or to assist the person in moving from one posture to another. Conventional lift systems utilize a sling or other lifting accessory to secure a person to the lift system and an actuator to lift the person to a different elevation or lower the person to a lower elevation. In one typical example, a caregiver operates the lift unit to raise the person off a person support surface (e.g., a bed), repositions the person by moving the lift system to a desired location, and then operates the lift unit again to lower the person to the destination.

Additionally, overhead support assemblies may be utilized to position a service column within a hospital room. A boom arm may extend between the service column and a ceiling mount to permit movement of the service column by positioning the boom arm. By incorporating a lift system into the boom arm, less space may be occupied within the hospital room, thereby providing additional space for medical personnel and equipment.

A need exists for methods for permitting such lift systems to be accommodated on a boom arm supporting a service column.

### SUMMARY

In one embodiment, an overhead support assembly includes: a boom arm having a length extending between a first end and an opposite second end of the boom arm, the length of the boom arm being equal to or greater than 1,500 mm and less than or equal to 1,700 mm; a rail mounted to a lower wall of the boom arm, the rail having a length extending between a first end and an opposite second end of the rail, the rail including a receiver, the length of the rail being equal to or greater than 1,500 mm and less than or equal to 1,700 mm; and a person lift system received within the receiver of the rail to translate along the rail between the first end and the second end of the rail.

In another embodiment, an overhead support assembly includes: a mounting device; a first connecting member extending from the mounting device; a boom arm having a length extending between a first end and an opposite second end of the boom arm, the boom arm rotatably coupled to the first connecting member proximate the second end of the boom arm; a rail mounted to a lower wall of the boom arm, the rail having a length extending between a first end and an opposite second end of the rail; a person lift system received within the rail to translate along the rail between the first end and the second end of the rail; a second connecting member extending from the boom arm proximate the first end of the boom arm; an accessory arm rotatably coupled to the second connecting member; and a service column rotatably coupled to the accessory arm proximate an end of the accessory arm opposite the boom arm, wherein a distance between the first end of the boom arm and a center of the second connecting member is equal to or greater than 200 mm and less than or equal to 400 mm, wherein a distance between the second end of the boom arm and a center of the first connecting member is equal to or greater than 200 mm and less than or equal to 400 mm.

In yet another embodiment, an overhead support assembly includes: a mounting device; a first connecting member extending from the mounting device; a boom arm having a first end and an opposite second end of the boom arm, the boom arm rotatably coupled to the first connecting member proximate the second end of the boom arm; a second connecting member extending from the boom arm proximate the first end of the boom arm; an accessory arm rotatably coupled to the second connecting member; a service column rotatably coupled to the accessory arm proximate an end of the accessory arm opposite the boom arm; a third connecting member extending from the mounting device and spaced apart from the first connecting member; a second boom arm having a length extending between a first end and an opposite second end of the boom arm, the boom arm rotatably coupled to the third connecting member proximate the second end of the boom arm; a rail mounted to a lower wall of the second boom arm, the rail having a length extending between a first end and an opposite second end of the rail; and a person lift system received within the receiver of the rail to translate along the rail between the first end and the second end of the rail, wherein a distance between the first end of the boom arm and a center of the second connecting member is equal to or greater than 200 mm and less than or equal to 400 mm, wherein a distance between the second end of the boom arm and a center of the first connecting member is equal to or greater than 200 mm and less than or equal to 400 mm.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a person seated in a lifting accessory and suspended from a person lift system of an overhead support assembly, according to one or more embodiments shown and described herein;

FIG. 2 schematically depicts a front view of the overhead support assembly of FIG. 1, according to one or more embodiments shown and described herein;

FIG. 3 schematically depicts a partial perspective view of a boom arm and a rail of the overhead support assembly of FIG. 1 with an end plate removed from the boom arm, according to one or more embodiments shown and described herein;

FIG. 4 schematically depicts a partial perspective view of the boom arm and the rail of the overhead support assembly of FIG. 1 including a protective cover installed within the boom arm, according to one or more embodiments shown and described herein;

FIG. 5 schematically depicts a partial bottom view of the rail of the overhead support assembly of FIG. 1, according to one or more embodiments shown and described herein;

FIG. 6 schematically depicts a partial perspective view of the boom arm and the rail of the overhead support assembly of FIG. 1 with an end plate removed from the rail, according to one or more embodiments shown and described herein;

FIG. 7 schematically depicts an end view of the rail with the end plate removed, according to one or more embodiments shown and described herein;

FIG. 8 schematically depicts a partial perspective cross-sectional view of a lift unit of the person lift system engaging the rail, according to one or more embodiments shown and described herein;

FIG. 9 schematically depicts a front view of another embodiment of an overhead support assembly, according to one or more embodiments shown and described herein; and

FIG. 10 schematically depicts a front view of another embodiment of an overhead support assembly, according to one or more embodiments shown and described herein.

### DETAILED DESCRIPTION

Reference will now be made in detail to embodiments of overhead support assemblies and methods of operating the same, examples of which are illustrated in the accompanying drawings. Whenever possible, the same reference numerals will be used throughout the drawings to refer to the same or like parts.

Embodiments of the overhead support assembly includes a person lift system translatable along a rail mounted to a lower side of a boom arm extending between a mounting device fixed to a ceiling or other support structure of a room and a service column.

Person lift systems are typically utilized within patient care environments, such as hospitals and rehabilitation facilities, and allow caregivers to reposition individuals or to change a person's posture while minimizing exertion of the caregiver. In addition to person lift systems, one or more service columns may be provided within the same environment and required to be regularly repositioned independent or simultaneously with the person lift system. Accordingly, such movements can be dangerous to those within the environment and limit the amount of available space.

An overhead lift support assembly that incorporates a boom arm for a service column can provide significant benefits by allowing both the service column and the person lift system to translate along the boom arm. This dual-function system not only facilitates precise positioning of utilities around a particular location, but also enables safe, efficient subject handling without interference from cords or equipment on the floor. By permitting the person lift system to move along the same boom arm as the service column, healthcare providers can seamlessly reposition both systems based on real-time needs, reducing the need for additional lift equipment and enhancing workflow in critical care areas like intensive care units and operating rooms.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein-for example up, down, right, left, front, back, top, bottom-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

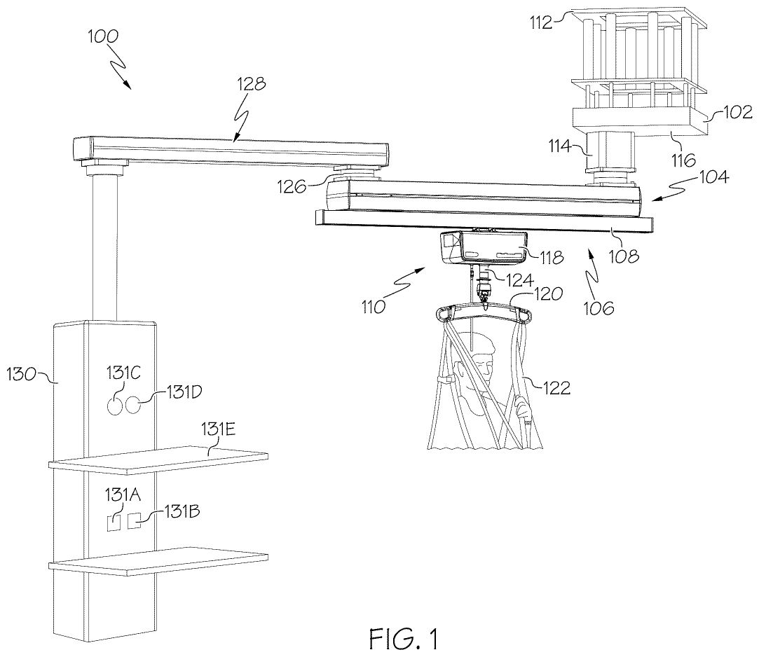

Referring now to FIG. 1, an overhead support assembly 100 is illustrated according to one or more embodiments described herein. The overhead support assembly 100 may generally include a mounting device 102, a boom arm 104 rotatably coupled to the mounting device 102, a rail 106 mounted to a lower wall 108 of the boom arm 104, and a person lift system 110 translatable along the rail 106.

The mounting device 102 is shown mounted to a ceiling 112 of a room and includes a first connecting member 114 extending from a lower wall 116 of the mounting device 102. It should be appreciated that the mounting device 102 includes one or more fastening members to secure the mounting device 102 to the ceiling 112 and accommodate the large amount of weight exhibited by a person supported by the person lift system 110 and/or one or more accessories, as described in more detail herein.

The boom arm 104 is rotatably coupled to the mounting device 102 via the first connecting member 114. Accordingly, the boom arm 104 may rotate in one or more rotation directions relative to the mounting device 102. As described herein, the rail 106 is mounted to the lower wall 108 of the boom arm 104 and the person lift system 110 is translatable along the rail 106. The boom arm 104 and the rail 106 are described in more detail herein.

The person lift system 110 includes a lift unit 118, a sling bar 120 that is coupled to the lift unit 118, and a lifting accessory 122 that is selectively coupled to the sling bar 120. In the depicted embodiment, the lift unit 118 translates along the rail 106, as described in more detail herein.

A lift strap 124 is connected at a first end to the lift unit 118 and is configured to be taken up or paid out from the lift unit 118. In embodiments, a quick-release link, also referred to as a “Q-link” or connector link, is coupled to a free second end of the lift strap 124, and the sling bar 120 is coupled to the quick-release link by a fastener.

The lift unit 118 may receive an input from a caregiver via a control device (not shown) coupled to the lift unit 118. The control device may include a wired controller and/or one or more wireless controllers. For example, in one embodiment, the control device may be a wired controller (such as a pendant or the like) or, alternatively, a controller integrated into the lift unit 118. In some embodiments, the controller may be in electronic communication with an electronic control unit of the sling bar 120. The electronic control unit may pass the control signal from the control device to the lift unit 118. In another embodiment, the controller may be a wireless controller such as a wireless hand control and/or a wireless diagnostic monitor/control. Based on the input received from the control device, the lift unit 118 may selectively pay out or take up lift strap 124.

Referring still to FIG. 1, the lifting accessory 122 is coupled to the sling bar 120 to support a person. In various embodiments, the lifting accessory 122 may include a lifting sling, a lifting vest, a lifting strap, a lifting sheet, or the like. The weight of the person is born by the sling bar 120 as a result of the lifting accessory 122 being suspended below the sling bar 120. Other devices for supporting a person or other load are possible and within the scope of the present disclosure.

In embodiments, the boom arm 104 includes a second connecting member 126 utilized to rotatably couple an accessory arm 128 to the boom arm 104. As shown in FIG. 1, a service column 130 extends from an end of the accessory arm 128 opposite the boom arm 104. The service column 130 is a flexible, oftentimes ceiling-mounted unit that houses essential medical utilities, such as power outlets 131A, gas lines 131B (e.g., oxygen and anesthesia), data ports 131C, and sometimes lighting 131D. In embodiments, the service column 130 includes one or more cabinets or shelves 131E for storing medical supplies. Unlike fixed installations, the service column 130 may be repositioned along ceiling tracks or extend from articulated arms, allowing healthcare providers to access vital services wherever they are needed within the room. This flexibility supports efficient patient care by enabling medical staff to bring services close to the patient's bedside, adjust room configurations, and easily accommodate different medical procedures or equipment layouts. In addition to maximizing space, the service column 130 improves safety and reduces clutter by keeping cords and hoses elevated, minimizing tripping hazards and creating a more streamlined environment. Their versatility is particularly valuable in high-demand settings like emergency rooms, intensive care units, and operating rooms, where rapid adaptability to different procedures and patient needs is essential.

Accordingly, the service column 130, and in turn the accessory arm 128, is rotatably coupled to the boom arm 104 and may be rotated relative to the boom arm 104. Movement of the accessory arm 128 and thus the service column 130 may be manually operated such as by applying a force in one or more rotation directions relative to the boom arm 104. Additionally, the service column 130 may be raised and lowered manually. As the accessory arm 128 is vertically fixed relative to the boom arm 104, vertical movement of the service column 130 increases or decreases a distance between an upper end of the service column 130 and the accessory arm 128. In embodiments, movement of the accessory arm 128 and/or the service column 130 may be inhibited by a brake mechanism. Accordingly, in such embodiments, the brake mechanism is operated, such as by a person desiring to move the accessory arm 128 and/or the service column 130, to disengage the brake mechanism and permit movement of the accessory arm 128 and/or the service column 130. It should be appreciated that any suitable brake mechanism may be utilized and is within the scope of the present disclosure.

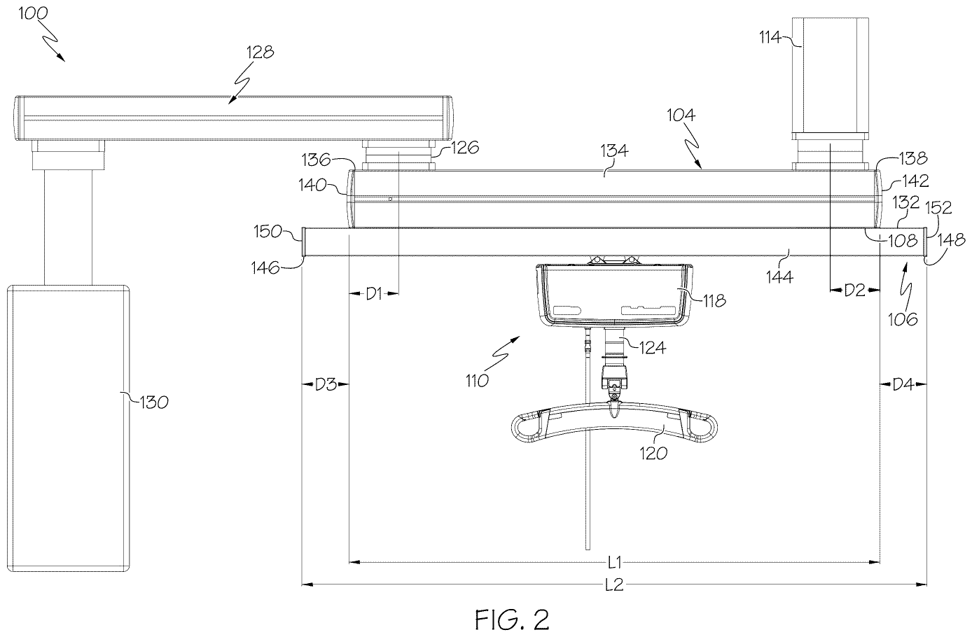

Referring now to FIG. 2, the overhead support assembly 100 is illustrated and an upper wall 132 of the rail 106 is shown mounted to the lower wall 108 of the boom arm 104. The boom arm 104 includes one or more side walls 134, a first end 136, and a second end 138 opposite the first end 136. The one or more side walls 134 extend between the first end 136 and the second end 138. In embodiments, a first end plate 140 is provided on the one or more side walls 134 at the first end 136, and a second end plate 142 is provided on the one or more side walls 134 at the second end 138. The boom arm 104 has any suitable cross-sectional shape such as, for example, square, rectangular, elliptical, and the like. The boom arm 104 has a length L1 extending between the first end 136 and the second end 138. In embodiments, the length L1 of the boom arm 104 is about 1,300 millimeters (mm). In embodiments, the length L1 of the boom arm 104 is equal to or greater than 1,000 mm and less than or equal to 1,600 mm. In embodiments, the length L1 of the boom arm 104 is equal to or greater than 1,100 mm and less than or equal to 1,500 mm. In embodiments, the length L1 of the boom arm 104 is equal to or greater than 1,200 mm and less than or equal to 1,400 mm. Additionally, the first end 136 of the boom arm 104 is spaced apart from a center of the second connecting member 126 by a distance D1, and the second end 138 of the boom arm 104 is spaced apart from a center of the first connecting member 114 by a distance D2. In embodiments, distance D1 and distance D2 are each about 150 mm. In embodiments, distance D1 and distance D2 are each equal to or greater than 100 mm and less than or equal to 200 mm.

The rail 106 includes one or more side walls 144, a first end 146, and a second end 148 opposite the first end 146. The one or more side walls 144 extends between the first end 146 and the second end 148. In embodiments, a first end plate 150 is provided on the one or more side walls 144 at the first end 146, and a second end plate 152 is provided on the one or more side walls 144 at the second end 148. The rail 106 has any suitable cross-sectional shape such as, for example, square, rectangular, elliptical, and the like. As described in more detail herein, the rail 106 has a square cross-sectional shape. The rail 106 has a length L2 extending between the first end 146 and the second end 148. In embodiments, the length L2 of the rail 106 is about 1,600 mm. In embodiments, the length L2 of the rail 106 is equal to or greater than 1,300 mm and less than or equal to 1,900 mm. In embodiments, the length L2 of the rail 106 is equal to or greater than 1,400 mm and less than or equal to 1,800 mm. In embodiments, the length L2 of the rail 106 is equal to or greater than 1,500 mm and less than or equal to 1,700 mm.

As shown, the length L1 of the boom arm 104 is less than the length L2 of the rail 106. Accordingly, as shown in FIG. 2, with the rail 106 centered on the boom arm 104, the first end 146 of the rail 106 extends past the first end 136 of the boom arm 104 by a distance D3, and the second end 148 of the rail 106 extends past the second end 138 of the boom arm 104 by a distance D4. In embodiments, distance D3 and distance D4 are equal to one another. In embodiments, distance D3 is greater than distance D4. In embodiments, distance D3 is less than distance D4. In embodiments, distance D3 and distance D4 are each about 150 mm. In embodiments, distance D3 and distance D4 are each equal to or greater than 100 mm and less than or equal to 200 mm. In embodiments, distance D3 and distance D4 are each equal to or greater than 125 mm and less than or equal to 175 mm. By permitting the rail 106 to extend past the first end 136 and the second end 138 of the boom arm 104, the total distance of travel of the person lift system 110, as described in more detail herein, is increased without needing to increase a length of the boom arm 104 itself.

As used herein, reference to an end of the rail 106 extending past an end of the boom arm 104 should be understood to mean that a portion of the upper wall 132 of the rail 106 at the respective end of the rail 106 does not overlap a portion of the boom arm 104 in a vertical direction.

In other embodiments, the first end 146 of the rail 106 may be flush mounted with the first end 136 of the boom arm 104 with the second end 148 of the rail 106 still extending past the second end 138 of the boom arm 104. In other embodiments, the second end 148 of the rail 106 may be flush mounted with the second end 138 of the boom arm 104 with the first end 146 of the rail 106 still extending past the first end 136 of the boom arm 104. In other embodiments, as described in more detail herein, the first end 146 of the rail 106 may be flush mounted with the first end 136 of the boom arm 104, and the second end 148 of the rail 106 may be flush mounted with the second end 138 of the boom arm 104.

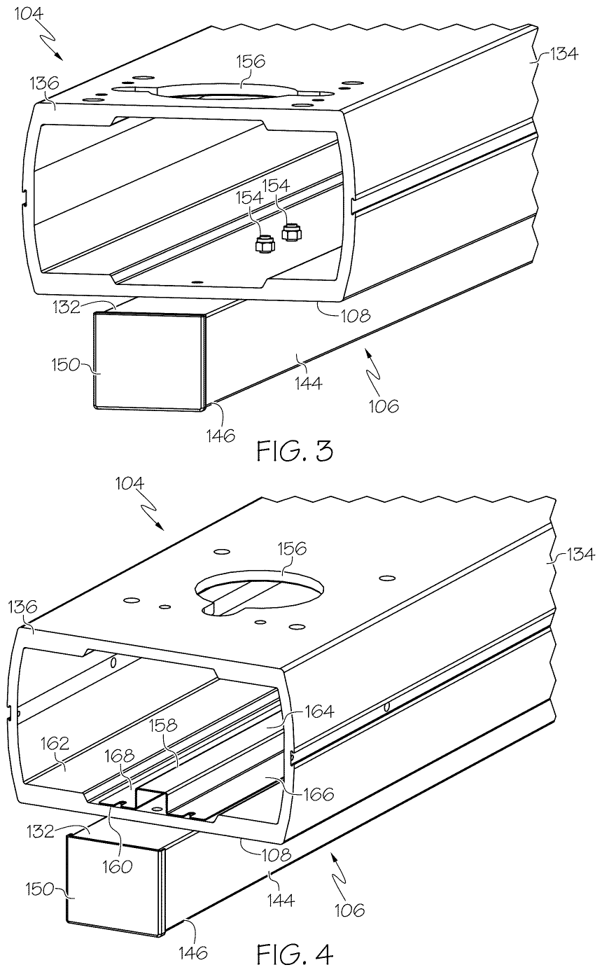

As shown in FIG. 3, the rail 106 is mounted to the boom arm 104. Specifically, as described herein, the upper wall 132 of the rail 106 is mounted to the lower wall 108 of the boom arm 104. The rail 106 may be mounted to the boom arm 104 in any suitable manner. As shown, a plurality of fasteners 154 extend through the lower wall 108 of the boom arm 104 and into the upper wall 132 of the rail 106. Although only a pair of fasteners 154 are illustrated, it should be appreciated that any number of fasteners 154, such as one fastener 154 as well as a plurality of pairs of fasteners 154 are provided along the length of the boom arm 104 and the length of the rail 106. Additionally, as shown in FIG. 3, the rail 106 has a square cross-sectional shape. As shown in FIG. 3, the boom arm 104 includes an aperture 156 formed proximate the first end 136 of the boom arm 104. The aperture 156 receives the second connecting member 126. Although not depicted, it should be appreciated that the boom arm 104 includes another aperture formed proximate the second end 138 of the boom arm 104 that receives the first connecting member 114.

As shown in FIG. 4, in embodiments, a protective cover 158 is provided over the fasteners 154 (FIG. 3) securing the rail 106 to the boom arm 104 and within a recess 160 formed in an upper surface 162 of the lower wall 108 of the boom arm 104. The protective cover 158 includes a raised portion 164, a first flange 166 extending from a first side of the raised portion 164, and a second flange 168 extending from an opposite second side of the raised portion 164. The first flange 166 and the second flange 168 is secured to the lower wall 108 of the boom arm 104 in any suitable matter such as by welding, fasteners, or the like. It should be appreciated that the raised portion 164 defines a cavity with the lower wall 108 of the boom arm 104 in which the fasteners 154 (FIG. 3) extend. Accordingly, the protective cover 158 prevents the fasteners 154 from being contacted by one or more component extending within an interior of the boom arm 104.

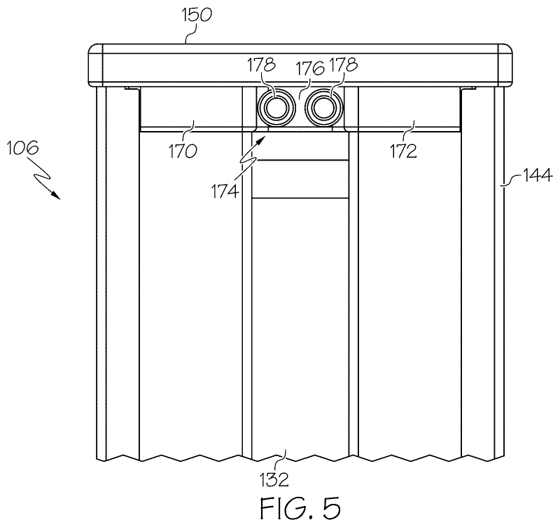

Referring now to FIG. 5, a bottom view of the rail 106 is depicted. As shown, the first end plate 150 of the rail 106 includes a protrusion 170 that extends in a direction so as to be received within an interior of the rail 106. The protrusion 170 includes a lower surface 172 and a recess 174 is formed in the protrusion 170 extending from the lower surface 172 toward an upper surface 176 of the protrusion 170 opposite the lower surface 172 of the protrusion 170. One or more holes 178 are formed in the upper surface 176 of the protrusion 170. As shown, a pair of holes 178 are formed in the upper surface 176 of the protrusion 170. However, in embodiments, only a single hole 178 may be formed. In embodiments, the holes 178 are threaded to permit a threaded fastener to engage the hole 178. Upon insertion of a fastener through the holes 178, the fastener contacts the upper wall 132 of the rail 106, thereby retaining the first end plate 150 on the rail 106. It should be appreciated that, although not illustrated herein, the second end plate 152 of the rail 106 includes similar structure to the first end plate 150.

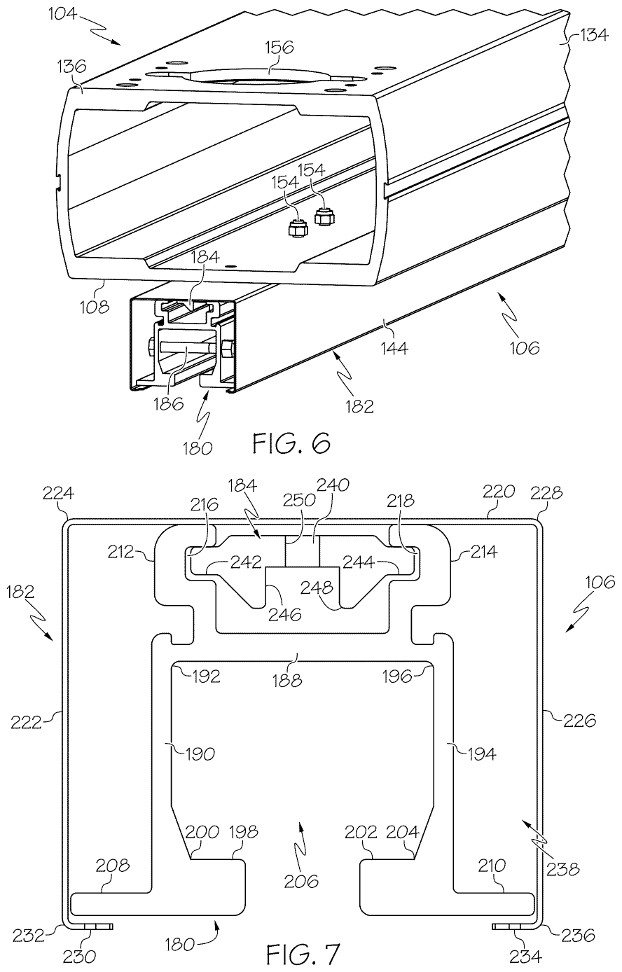

Referring now to FIG. 6, the rail 106 is shown mounted to the lower wall 108 of the boom arm 104 with the first end plate 150 of the rail 106 removed. The rail 106 includes a receiver 180, a housing 182 at least partially surrounding the receiver 180, and one or more mounting members 184 mounted to the lower wall 108 of the boom arm 104. In embodiments, a hard stop 186 extends across the receiver 180 to prevent over extension of the person lift system 110 (FIG. 1) along the rail 106, as described in more detail herein. Although only a single mounting member 184 is shown, it should be appreciated that a plurality of mounting members 184 may be provided along the length of the rail 106 and each secured to the lower wall 108 of the boom arm 104 by one or more fasteners 154.

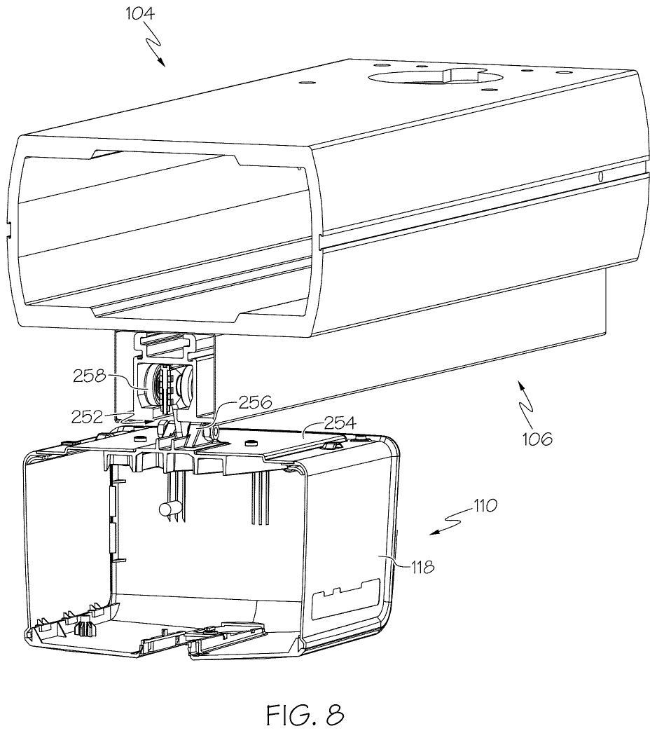

With more particularity and with reference to FIG. 7, a cross-sectional view of the rail 106 is depicted including the receiver 180, the housing 182, and one of the mounting members 184. The receiver 180 includes a medial wall 188, a first side wall 190 extending from a first edge 192 of the medial wall 188, a second side wall 194 extending from a second edge 196 of the medial wall 188 opposite the first edge 192, a first track wall 198 extending from a lower end 200 of the first side wall 190 opposite the medial wall 188, and a second track wall 202 extending from a lower end 204 of the second side wall 194 opposite the medial wall 188. The medial wall 188, the first side wall 190, the second side wall 194, the first track wall 198, and the second track wall 202 define an open interior 206 of the receiver 180. In embodiments, the receiver 180 further includes a first flange 208 extending from the lower end 200 of the first side wall 190 in a direction opposite the first track wall 198, and a second flange 210 extending from the lower end 204 of the second side wall 194 in a direction opposite the second track wall 202. In embodiments, the receiver 180 further includes a first upper arm 212 extending from the medial wall 188 proximate the first edge 192 of the medial wall 188 in a direction opposite the first side wall 190, and a second upper arm 214 extending from the medial wall 188 proximate the second edge 196 of the medial wall 188 in a direction opposite the second side wall 194. The first upper arm 212 defines a first channel 216, and the second upper arm 214 defines a second channel 218.

The housing 182 includes an upper wall 220, a first side wall 222 extending from a first edge 224 of the upper wall 220, a second side wall 226 extending from a second edge 228 of the upper wall 220 opposite the first edge 224, a first flange 230 extending from a lower end 232 of the first side wall 222 opposite the upper wall 220, and a second flange 234 extending from a lower end 236 of the second side wall 226 opposite the upper wall 220. The first flange 230 and the second flange 234 each extend toward one another and terminate to define a gap therebetween. The upper wall 220, the first side wall 222, the second side wall 226, the first flange 230, and the second flange 234 define an open interior 238 of the housing 182.

The mounting member 184 includes a base wall 240. The base wall 240 defines a first finger 242 extending in a first direction, and a second finger 244 extending in a second direction opposite the first direction. In embodiments, a recess 246 is formed in a lower surface 248 of the base wall 240 and a hole 250 extends through the base wall 240 from the recess 246. Although only a single hole 250 is illustrated, it should be appreciated that any number of holes 250, for example, two holes 250 or more than two holes 250, may be formed in the mounting member 184.

As shown in FIG. 7, the mounting member 184 engages the receiver 180 such that the first finger 242 of the base wall 240 is received within the first channel 216 of the first upper arm 212 of the receiver 180, and the second finger 244 of the base wall 240 is received within the second channel 218 of the second upper arm 214 of the receiver 180. Additionally, the receiver 180 is positioned within the open interior 238 of the housing 182 such that the first flange 208 rests of the receiver 180 rests on the first flange 230 of the housing 182, and the second flange 210 of the receiver 180 rests on the second flange 234 of the housing 182. Accordingly, with the mounting member 184 engaged with the receiver 180, the housing 182 reduces the weight of the receiver 180 on the mounting member 184. A fastener 154, as described herein and shown in FIG. 6, extends through each hole 250, and through the housing 182, to secure the mounting member 184 and the housing 182, and thus the receiver 180, to the boom arm 104 (FIG. 6).

Referring now to FIG. 8, the manner in which the lift unit 118 is operate to translate along the rail 106 is depicted in more detail. Specifically, the person lift system 110 includes a trolley member 252 mounted to an upper wall 254 of the lift unit 118. The trolley member 252 includes a trolley mount 256 and at least one roller 258 rotatably coupled to the trolley mount 256. The at least one roller 258 is positioned at least partially within the rail 106, thereby coupling the lift unit 118 to the rail 106. Particularly, the at least one roller 258 is positioned within the open interior 206 of the receiver 180 such that the one or more rollers 258 is supported on the first track wall 198 and/or the second track wall 202. With the at least one roller 258 positioned within the rail 106, the lift unit 118 is movable along the rail 106. Accordingly, a person coupled to the lift unit 118 via the sling bar 120 and the lifting accessory 122 (FIG. 1) may be moved between different locations along the rail 106. In embodiments, the at least one roller 258 may include any suitable structure rotatably coupled to the trolley mount 256 that allows the lift unit 118 to move along the rail 106, and may define a cylindrical or spherical shape positioned within and engaged with the rail 106. In the embodiment depicted in FIG. 8, the trolley member 252 includes two rollers 258, however, it should be understood that the trolley member 252 may include any suitable number of rollers 258 coupled to the trolley mount 256 and positioned within the rail 106.

Although not depicted herein, in embodiments, the rail 106 includes a rail power source. The rail power source may provide electrical power to the lift unit 118. In embodiments, the rail power source may be coupled to the rollers 258, which may be formed from a conductive material.

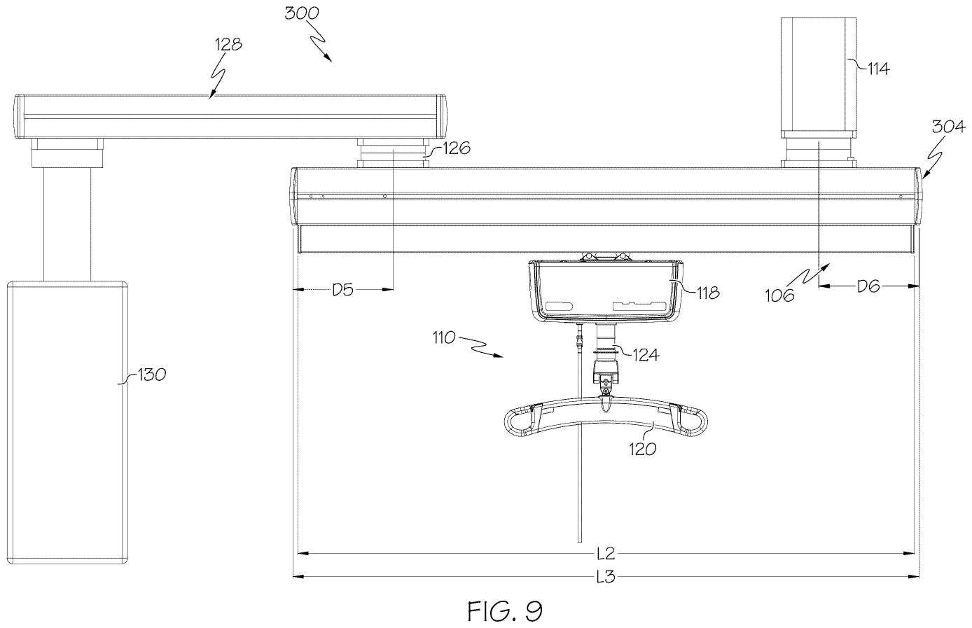

Referring now to FIG. 9, another embodiment of an overhead support assembly 300 is depicted. It should be appreciated that the overhead support assembly 300 is similar to the overhead support assembly 100 described herein and illustrated in FIG. 2. Therefore, like reference numbers will be used to refer to like parts.

Similar to the overhead support assembly 100 of FIG. 2, the overhead support assembly 300 includes the mounting device 102 (FIG. 1), a boom arm 304 rotatably coupled to the mounting device 102 via the first connecting member 114, the accessory arm 128 rotatably coupled to the boom arm 304 via the second connecting member 126, the service column 130 extending from the accessory arm 128, the rail 106 mounted to the lower wall 108 of the boom arm 304, and the person lift system 110 translatable along the rail 106. As described herein, the rail 106 has a length L2. However, the boom arm 304 has a length L3 greater than the length L1 of the boom arm 104 of the overhead support assembly 100 of FIG. 2. In embodiments, the length L3 of the boom arm 304 is greater than the length L2 of the rail 106. In other embodiments, the length L3 of the boom arm 304 is equal to the length L2 of the rail 106.

As shown in FIG. 9, the length L3 of the boom arm 304 is greater than the length L2 of the rail 106. Accordingly, the first end 136 of the boom arm 304 is spaced apart from the center of the second connecting member 126 by a distance D5, which is greater than the distance D1 (FIG. 2), and the second end 138 of the boom arm 304 is spaced apart from the center of the first connecting member 114 by a distance D6, which is greater than the distance D2. In embodiments, distance D5 and distance D6 are each about 300 mm. In embodiments, distance D5 and distance D6 are each equal to or greater than 200 mm and less than or equal to 400 mm. In embodiments, distance D5 and distance D6 are each equal to or greater than 250 mm and less than or equal to 350 mm.

In embodiments, the length L3 of the boom arm 304 is about 1,600 mm. In embodiments, the length L3 of the boom arm 304 is equal to or greater than 1,300 mm and less than or equal to 1,900 mm. In embodiments, the length L3 of the boom arm 304 is equal to or greater than 1,400 mm and less than or equal to 1,800 mm. In embodiments, the length L3 of the boom arm 304 is equal to or greater than 1,500 mm and less than or equal to 1,700 mm. In embodiments, a difference between the length L2 of the rail 106 and the length L3 of the boom arm 304 is less than or equal to 50 mm. In embodiments, a difference between the length L2 of the rail 106 and the length L3 of the boom arm 304 is less than or equal to 40 mm.

In embodiments, a difference between the length L2 of the rail 106 and the length L3 of the boom arm 304 is less than or equal to 30 mm. In embodiments, a difference between the length L2 of the rail 106 and the length L3 of the boom arm 304 is less than or equal to 20 mm. In embodiments, a difference between the length L2 of the rail 106 and the length L3 of the boom arm 304 is less than or equal to 10 mm. In embodiments, a difference between the length L2 of the rail 106 and the length L3 of the boom arm 304 is less than or equal to 5 mm.

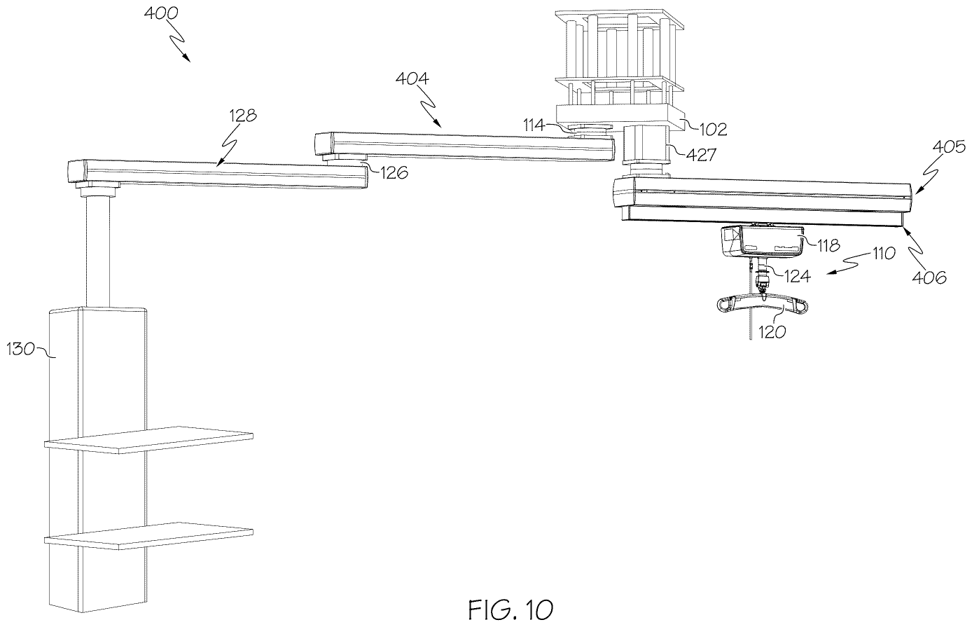

Referring now to FIG. 10, another embodiment of an overhead support assembly 400 is depicted. It should be appreciated that the overhead support assembly 400 is similar to the overhead support assembly 100 described herein and illustrated in FIG. 2. Therefore, like reference numbers will be used to refer to like parts.

Similar to the overhead support assembly 100 of FIG. 2, the overhead support assembly 400 includes the mounting device 102, a boom arm 404 rotatably coupled to the mounting device 102 via the first connecting member 114, the accessory arm 128 rotatably coupled to the boom arm 404 via the second connecting member 126, and the service column 130 extending from the accessory arm 128. However, the overhead support assembly 400 includes a second boom arm 405 rotatably coupled to the mounting device 102 via a third connecting member 427 and the person lift system 110 translatable along the second boom arm 405 via a rail 406 similar to the rail 106 of the overhead support assembly 100 of FIG. 2. The third connecting member 427 is spaced apart from the first connecting member 114. Accordingly, it should be appreciated that the concept of a rail mounted to a lower wall of a boom arm is equally applicable in situations in which a service column is not directly coupled to the boom arm 404, as depicted in FIG. 10. However, the above description is equally applicable to the second boom arm 405 and the rail 406.

From the above, it is to be appreciated that defined herein is an overhead support assembly including a boom arm and a rail mounted to a lower wall of the boom arm. In embodiments, a length of the rail is greater than a length of the boom arm to extend a total distance of travel of a person lift system along the rail without necessarily extending a length of the boom arm. In other embodiments, the length of the boom arm is equal to the length of the rail. In other embodiments, the length of the boom arm is equal to the length of the rail. However, by increasing a length of the boom arm, a distance between opposite ends of the boom arm and respective connecting members rotatably coupling the boom arm to a mounting device or an accessory arm is increased.

Further aspects of the embodiments described herein are provided by the subject matter of the following clauses:

An overhead support assembly comprising: a boom arm having a length extending between a first end and an opposite second end of the boom arm; a rail mounted to a lower wall of the boom arm, the rail having a length extending between a first end and an opposite second end of the rail, the rail including a receiver; and a person lift system received within the receiver of the rail to translate along the rail between the first end and the second end of the rail.

The overhead support assembly of any preceding clause, wherein the length of the rail is greater than the length of the boom arm.

The overhead support assembly of any preceding clause, wherein the length of the boom arm is equal to or greater than 1,200 mm and less than or equal to 1,400 mm.

The overhead support assembly of any preceding clause, wherein the first end of the rail extends past the first end of the boom arm.

The overhead support assembly of any preceding clause, wherein a distance between the first end of the rail and the first end of the boom arm is equal to or greater than 100 mm and less than or equal to 200 mm.

The overhead support assembly of any preceding clause, wherein the second end of the rail extends past the second end of the boom arm.

The overhead support assembly of any preceding clause, wherein a distance between the second end of the rail and the second end of the boom arm is equal to or greater than 100 mm and less than or equal to 200 mm.

The overhead support assembly of any preceding clause, wherein a difference between the length of the rail and the length of the boom arm is less than or equal to 50 mm.

The overhead support assembly of any preceding clause, wherein a difference between the length of the rail and the length of the boom arm is less than or equal to 10 mm.

The overhead support assembly of any preceding clause, wherein the rail comprises: a housing defining an open interior; a receiver defining an open interior, the receiver positioned within the open interior of the housing; and one or more mounting members positioned within the open interior of the receiver, the one or more mounting members engaging the receiver and secured to the boom arm.

The overhead support assembly of any preceding clause, wherein: the housing includes a first flange and a second flange opposite the first flange; the receiver includes a first flange and a second flange opposite the first flange; the first flange of the receiver rests on the first flange of the housing; and the second flange of the receiver rests on the second flange of the housing.

An overhead support assembly comprising: a mounting device; a first connecting member extending from the mounting device; a boom arm having a length extending between a first end and an opposite second end of the boom arm, the boom arm rotatably coupled to the first connecting member proximate the second end of the boom arm; a rail mounted to a lower wall of the boom arm, the rail having a length extending between a first end and an opposite second end of the rail; a person lift system received within the rail to translate along the rail between the first end and the second end of the rail; a second connecting member extending from the boom arm proximate the first end of the boom arm; an accessory arm rotatably coupled to the second connecting member; and a service column rotatably coupled to the accessory arm proximate an end of the accessory arm opposite the boom arm.

The overhead support assembly of any preceding clause, wherein the length of the rail is greater than the length of the boom arm.

The overhead support assembly of any preceding clause, wherein the length of the boom arm is equal to or greater than 1,200 mm and less than or equal to 1,400 mm.

The overhead support assembly of any preceding clause, wherein the first end of the rail extends past the first end of the boom arm.

The overhead support assembly of any preceding clause, wherein a distance between the first end of the rail and the first end of the boom arm is equal to or greater than 100 mm and less than or equal to 200 mm.

The overhead support assembly of any preceding clause, wherein the second end of the rail extends past the second end of the boom arm.

The overhead support assembly of any preceding clause, wherein a distance between the second end of the rail and the second end of the boom arm is equal to or greater than 100 mm and less than or equal to 200 mm.

The overhead support assembly of any preceding clause, wherein a difference between the length of the rail and the length of the boom arm is less than or equal to 50 mm.

The overhead support assembly of any preceding clause, wherein a difference between the length of the rail and the length of the boom arm is less than or equal to 10 mm.

The overhead support assembly of any preceding clause, wherein a distance between the first end of the boom arm and a center of the second connecting member is equal to or greater than 200 mm and less than or equal to 400 mm.

The overhead support assembly of any preceding clause, wherein a distance between the second end of the boom arm and a center of the first connecting member is equal to or greater than 200 mm and less than or equal to 400 mm.

The overhead support assembly of any preceding clause, wherein the rail comprises: a housing defining an open interior; a receiver defining an open interior, the receiver positioned within the open interior of the housing; and one or more mounting members positioned within the open interior of the receiver, the one or more mounting members engaging the receiver and secured to the boom arm.

The overhead support assembly of any preceding clause, wherein: the housing includes a first flange and a second flange opposite the first flange; the receiver includes a first flange and a second flange opposite the first flange; the first flange of the receiver rests on the first flange of the housing; and the second flange of the receiver rests on the second flange of the housing.

The overhead support assembly of any preceding clause, wherein the service column includes at least one power outlet, at least one medical gas outlet, and at least one shelf.

The overhead support assembly of any preceding clause, further comprising a brake mechanism for inhibiting movement of service column relative to the accessory arm.

An overhead support assembly comprising: a mounting device; a first connecting member extending from the mounting device; a boom arm having a first end and an opposite second end of the boom arm, the boom arm rotatably coupled to the first connecting member proximate the second end of the boom arm; a second connecting member extending from the boom arm proximate the first end of the boom arm; an accessory arm rotatably coupled to the second connecting member; a service column rotatably coupled to the accessory arm proximate an end of the accessory arm opposite the boom arm; a third connecting member extending from the mounting device and spaced apart from the first connecting member; a second boom arm having a length extending between a first end and an opposite second end of the boom arm, the boom arm rotatably coupled to the third connecting member proximate the second end of the boom arm; a rail mounted to a lower wall of the second boom arm, the rail having a length extending between a first end and an opposite second end of the rail; and a person lift system received within the rail to translate along the rail between the first end and the second end of the rail.

The overhead support assembly of any preceding clause, wherein the length of the rail is greater than the length of the second boom arm.

The overhead support assembly of any preceding clause, wherein the length of the second boom arm is equal to or greater than 1,200 mm and less than or equal to 1,400 mm.

The overhead support assembly of any preceding clause, wherein the first end of the rail extends past the first end of the second boom arm.

The overhead support assembly of any preceding clause, wherein a distance between the first end of the rail and the first end of the second boom arm is equal to or greater than 100 mm and less than or equal to 200 mm.

The overhead support assembly of any preceding clause, wherein the second end of the rail extends past the second end of the second boom arm.

The overhead support assembly of any preceding clause, wherein a distance between the second end of the rail and the second end of the second boom arm is equal to or greater than 100 mm and less than or equal to 200 mm.

The overhead support assembly of any preceding clause, wherein a difference between the length of the rail and the length of the second boom arm is less than or equal to 50 mm.

The overhead support assembly of any preceding clause, wherein a difference between the length of the rail and the length of the second boom arm is less than or equal to 10 mm.

The overhead support assembly of any preceding clause, wherein a distance between the second end of the second boom arm and a center of the third connecting member is equal to or greater than 200 mm and less than or equal to 400 mm.

The overhead support assembly of any preceding clause, wherein the rail comprises: a housing defining an open interior; a receiver defining an open interior, the receiver positioned within the open interior of the housing; and one or more mounting members positioned within the open interior of the receiver, the one or more mounting members engaging the receiver and secured to the second boom arm.

The overhead support assembly of any preceding clause, wherein: the housing includes a first flange and a second flange opposite the first flange; the receiver includes a first flange and a second flange opposite the first flange; the first flange of the receiver rests on the first flange of the housing; and the second flange of the receiver rests on the second flange of the housing.

The overhead support assembly of any preceding clause, wherein the service column includes at least one power outlet, at least one medical gas outlet, and at least one shelf.

The overhead support assembly of any preceding clause, further comprising a brake mechanism for inhibiting movement of service column relative to the accessory arm.

An overhead support assembly comprising: a boom arm having a length extending between a first end and an opposite second end of the boom arm, the length of the boom arm being equal to or greater than 1,500 mm and less than or equal to 1,700 mm; a rail mounted to a lower wall of the boom arm, the rail having a length extending between a first end and an opposite second end of the rail, the rail including a receiver, the length of the rail being equal to or greater than 1,500 mm and less than or equal to 1,700 mm; and a person lift system received within the receiver of the rail to translate along the rail between the first end and the second end of the rail.

An overhead support assembly comprising: a mounting device; a first connecting member extending from the mounting device; a boom arm having a length extending between a first end and an opposite second end of the boom arm, the boom arm rotatably coupled to the first connecting member proximate the second end of the boom arm; a rail mounted to a lower wall of the boom arm, the rail having a length extending between a first end and an opposite second end of the rail; a person lift system received within the rail to translate along the rail between the first end and the second end of the rail; a second connecting member extending from the boom arm proximate the first end of the boom arm; an accessory arm rotatably coupled to the second connecting member; and a service column rotatably coupled to the accessory arm proximate an end of the accessory arm opposite the boom arm, wherein a distance between the first end of the boom arm and a center of the second connecting member is equal to or greater than 200 mm and less than or equal to 400 mm, wherein a distance between the second end of the boom arm and a center of the first connecting member is equal to or greater than 200 mm and less than or equal to 400 mm.

An overhead support assembly comprising: a mounting device; a first connecting member extending from the mounting device; a boom arm having a first end and an opposite second end of the boom arm, the boom arm rotatably coupled to the first connecting member proximate the second end of the boom arm; a second connecting member extending from the boom arm proximate the first end of the boom arm; an accessory arm rotatably coupled to the second connecting member; a service column rotatably coupled to the accessory arm proximate an end of the accessory arm opposite the boom arm; a third connecting member extending from the mounting device and spaced apart from the first connecting member; a second boom arm having a length extending between a first end and an opposite second end of the boom arm, the boom arm rotatably coupled to the third connecting member proximate the second end of the boom arm; a rail mounted to a lower wall of the second boom arm, the rail having a length extending between a first end and an opposite second end of the rail; and a person lift system received within the rail to translate along the rail between the first end and the second end of the rail, wherein a distance between the first end of the second boom arm and a center of the second connecting member is equal to or greater than 200 mm and less than or equal to 400 mm, wherein a distance between the second end of the second boom arm and a center of the first connecting member is equal to or greater than 200 mm and less than or equal to 400 mm.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An overhead support assembly comprising:
a boom arm having a length extending between a first end and an opposite second end of the boom arm, the length of the boom arm being equal to or greater than 1,500 mm and less than or equal to 1,700 mm;
a rail mounted to a lower wall of the boom arm, the rail having a length extending between a first end and an opposite second end of the rail, the rail including a receiver, the length of the rail being equal to or greater than 1,500 mm and less than or equal to 1,700 mm; and
a person lift system received within the receiver of the rail to translate along the rail between the first end and the second end of the rail.

2. The overhead support assembly of claim 1, wherein the length of the rail is greater than the length of the boom arm.

3. The overhead support assembly of claim 2, wherein the first end of the rail extends past the first end of the boom arm.

4. The overhead support assembly of claim 3, wherein a distance between the first end of the rail and the first end of the boom arm is equal to or greater than 100 mm and less than or equal to 200 mm.

5. The overhead support assembly of claim 3, wherein the second end of the rail extends past the second end of the boom arm.

6. The overhead support assembly of claim 5, wherein a distance between the second end of the rail and the second end of the boom arm is equal to or greater than 100 mm and less than or equal to 200 mm.

7. The overhead support assembly of claim 1, wherein a difference between the length of the rail and the length of the boom arm is less than or equal to 50 mm.

8. The overhead support assembly of claim 7, wherein a difference between the length of the rail and the length of the boom arm is less than or equal to 10 mm.

9. The overhead support assembly of claim 1, wherein the rail comprises:
a housing defining an open interior;
a receiver defining an open interior, the receiver positioned within the open interior of the housing; and
one or more mounting members positioned within the open interior of the receiver, the one or more mounting members engaging the receiver and secured to the boom arm.

10. The overhead support assembly of claim 9, wherein:
the housing includes a first flange and a second flange opposite the first flange;
the receiver includes a first flange and a second flange opposite the first flange;
the first flange of the receiver rests on the first flange of the housing; and
the second flange of the receiver rests on the second flange of the housing.

11. An overhead support assembly comprising:
a mounting device;
a first connecting member extending from the mounting device;
a boom arm having a length extending between a first end and an opposite second end of the boom arm, the boom arm rotatably coupled to the first connecting member proximate the second end of the boom arm;
a rail mounted to a lower wall of the boom arm, the rail having a length extending between a first end and an opposite second end of the rail;
a person lift system received within the rail to translate along the rail between the first end and the second end of the rail;
a second connecting member extending from the boom arm proximate the first end of the boom arm;
an accessory arm rotatably coupled to the second connecting member; and
a service column rotatably coupled to the accessory arm proximate an end of the accessory arm opposite the boom arm,
wherein a distance between the first end of the boom arm and a center of the second connecting member is equal to or greater than 200 mm and less than or equal to 400 mm,
wherein a distance between the second end of the boom arm and a center of the first connecting member is equal to or greater than 200 mm and less than or equal to 400 mm.

12. The overhead support assembly of claim 11, wherein the length of the rail is greater than the length of the boom arm.

13. The overhead support assembly of claim 11, wherein a difference between the length of the rail and the length of the boom arm is less than or equal to 50 mm.

14. The overhead support assembly of claim 13, wherein a difference between the length of the rail and the length of the boom arm is less than or equal to 10 mm.

15. The overhead support assembly of claim 11, wherein the rail comprises:
a housing defining an open interior;
a receiver defining an open interior, the receiver positioned within the open interior of the housing; and
one or more mounting members positioned within the open interior of the receiver, the one or more mounting members engaging the receiver and secured to the boom arm.

16. The overhead support assembly of claim 15, wherein:
the housing includes a first flange and a second flange opposite the first flange;
the receiver includes a first flange and a second flange opposite the first flange;
the first flange of the receiver rests on the first flange of the housing; and
the second flange of the receiver rests on the second flange of the housing.

17. An overhead support assembly comprising:
a mounting device;
a first connecting member extending from the mounting device;
a boom arm having a first end and an opposite second end of the boom arm, the boom arm rotatably coupled to the first connecting member proximate the second end of the boom arm;
a second connecting member extending from the boom arm proximate the first end of the boom arm;
an accessory arm rotatably coupled to the second connecting member;
a service column rotatably coupled to the accessory arm proximate an end of the accessory arm opposite the boom arm;
a third connecting member extending from the mounting device and spaced apart from the first connecting member;
a second boom arm having a length extending between a first end and an opposite second end of the boom arm, the boom arm rotatably coupled to the third connecting member proximate the second end of the boom arm;
a rail mounted to a lower wall of the second boom arm, the rail having a length extending between a first end and an opposite second end of the rail; and
a person lift system received within the rail to translate along the rail between the first end and the second end of the rail,
wherein a distance between the first end of the second boom arm and a center of the second connecting member is equal to or greater than 200 mm and less than or equal to 400 mm,
wherein a distance between the second end of the second boom arm and a center of the first connecting member is equal to or greater than 200 mm and less than or equal to 400 mm.

18. The overhead support assembly of claim 17, wherein the length of the second boom arm is equal to or greater than 1,500 mm and less than or equal to 1,700 mm.

19. The overhead support assembly of claim 17, wherein a difference between the length of the rail and the length of the second boom arm is less than or equal to 50 mm.

20. The overhead support assembly of claim 17, wherein the rail comprises:
a housing defining an open interior, the housing including a first flange and a second flange opposite the first flange;
a receiver defining an open interior, the receiver positioned within the open interior of the housing, the receiver including a first flange and a second flange opposite the first flange, the first flange of the receiver resting on the first flange of the housing, the second flange of the receiver resting on the second flange of the housing; and
one or more mounting members positioned within the open interior of the receiver, the one or more mounting members engaging the receiver and secured to the second boom arm.
